(19) United States
(12) Patent Application Publication
(10) Pub. No.: US 2007/0210959 A1
(43) Pub. Date: Sep. 13, 2007

(54) Multi-beam tile array module for phased array systems

(75) Inventors: Jeffrey Herd, Rowley, MA (US); Sean M. Duffy, Stow, MA (US); Glenn A. Brigham, Chelmsford, MA (US); Larry L. Retherford, Merrimack, NH (US); Francis G. Willwerth, Arlington, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Massachusetts Institute of Technology, Cambridge, MA (US)

(21) Appl. No.: 11/369,575

(22) Filed: Mar. 7, 2006

(51) Int. Cl. H01Q 3/00

(52) U.S. Cl. 342/368

(57) ABSTRACT

Described is a tile module for a phased array system. The tile module includes array elements configured in a two-dimensional array which is part of a larger subarray in the phased array system. A control module communicates with each array element to control a phase shift and an attenuation. In one embodiment a two-dimensional overlapped subarray manifold provides a weighted combination of RF signals received by the array elements of the tile module and array elements of other tile modules disposed in the same subarray of the phased array system. In another embodiment the two-dimensional overlapped subarray manifold distributes to the array elements weighted combinations of transmit RF signals applied to the tile module and other tile modules disposed in the same subarray. Advantageously, tile modules can be fabricated in large quantities, can be tested and calibrated independently, and can easily be installed or replaced in the phased array system.

### GOVERNMENT RIGHTS IN THE INVENTION

This invention was made with United States government support under Contract No. F19628-00-C-0002 awarded by the United States Air Force. The government may have certain rights in the invention.

### FIELD OF THE INVENTION

The present invention relates generally to phased array systems and more particularly to a conformal tile module for phased array systems.

### BACKGROUND OF THE INVENTION

Early implementations of phased array systems were based on passive arrays that included a centralized transmitter and receiver module and a phase shifter at each array element. The passive corporate feed networks for such radar systems introduced high losses. Ferrite phase shifters were typically employed due to their low loss; however, ferrite phase shifters are generally large and heavy devices. Active array systems were developed due in part to advances in microwave integrated circuits and have improved radar sensitivity due to lower radio frequency (RF) losses than passive arrays. Each element of an active array system includes a transmitter and receiver module (i.e., “T/R module”) having a phase shifter and amplifiers. Advantageously, active arrays can continue to operate with only gradual degradation as the number of failed array elements increases.

Mission performance requirements for phased array systems have become more demanding. For example, phased array systems providing a surveillance function are often limited to a single mode of operation or surveillance task. Redundant systems may be required to accommodate simultaneous modes of operations. Moreover, the weight and size of a phased array system are important factors for airborne and spaceborne implementations. Lower cost is desired to accelerate development of more sophisticated systems, including systems with greater numbers of T/R modules than current phased array systems.

A phased array system having a digital channel for each array element provides the most operational flexibility. Multiple beams can be formed simultaneously over a defined angle space and full adaptive control is possible; however, significant digital processing capability is required. Furthermore, fitting all of the components, including receivers and analog to digital converters, in a small volume near each element provides a significant challenge. The DC power requirements, thermal management, and cost of components are additional barriers to implementation of such systems.

Phased array systems employing digital subarrays represent a compromise between single agile beam systems with analog beamformers and all-digital systems employing digital beamformers. The density of digital channels used with digital subarrays is significantly less than the number of array elements. As a result, digital processing requirements are reduced. However, the system size and the cost and complexity of the subarray networks make them unsuitable for many applications. In addition, modification or replacement of a portion of the array elements is difficult and can require significant down time.

### SUMMARY OF THE INVENTION

In one aspect, the invention features a tile module for a phased array system. The tile module includes a plurality of array elements, a plurality of controller modules and a two-dimensional network module. The array elements are configured as a two-dimensional array and each array element is adapted for receiving an RF signal. Each controller module is in communication with a respective one of the array elements and provides a phase shift and an attenuation. The two-dimensional network module includes a portion of an overlapped subarray manifold and is in communication with the array elements. The two-dimensional network module provides a weighted combination of received RF signals from the array elements of the tile module and array elements in other tile modules disposed in a same subarray of the phased array system.

In another aspect, the invention features a tile module for a phased array system. The tile module includes a plurality of array elements, a plurality of controller modules, a plurality of one-dimensional network modules and an orthogonal one-dimensional network module. The array elements are configured as a two-dimensional array and each array element is adapted for receiving an RF signal. Each controller module is in communication with a respective one of the array elements and provides a phase shift and an attenuation. Each one-dimensional network module is in communication with a respective subset of the array elements and generates a first weighted combination of the RF signals received by the respective subset of the array elements. The orthogonal one-dimensional network module is in communication with the one-dimensional network modules and generates an orthogonal weighted combination in response to the first weighted combinations of the RF signals received from the one-dimensional network modules.

In still another aspect, the invention features a tile module for a phased array system. The tile module includes a plurality of array elements, a plurality of controller modules and a two-dimensional network module. The array elements are configured as a two dimensional array and each array element is adapted for transmitting an RF signal. Each controller module is in communication with a respective one of the array elements and provides a phase shift and an attenuation. The two-dimensional network module includes a portion of an overlapped subarray manifold and is in communication with the array elements. The two-dimensional network module provides to each array element a weighted combination of transmit RF signals applied to the tile module and other tile modules disposed in a same subarray of the phased array system.

In yet another aspect, the invention features a tile module for a phased array system. The tile module includes a plurality of array elements, a plurality of controller modules, a one-dimensional network module and a plurality of orthogonal network modules. The array elements are configured as a two dimensional array and are each adapted for transmitting an RF signal. Each controller module is in communication with a respective one of the array elements and provides a phase shift and an attenuation. The one-dimensional network module has an input terminal to receive a transmit RF signal and generates a first plurality of weighted transmit RF signals. Each orthogonal network module is in communication with the one-dimensional network module and a subset of the array elements. Each orthogonal network module generates weighted combinations of weighted transmit RF signals and each of the weighted combinations is provided to a respective one of the array elements.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a block diagram depicting a conventional active array system.

FIG. 2 is a block diagram depicting an active array system having a digital channel for each array element.

FIG. 3 is a block diagram depicting an active array system having an analog overlapped subarray network.

FIG. 4A is a graphical depiction of an example of an aperture for the active array system shown in FIG. 3 showing the location of a subarray.

FIG. 4B is a graphical depiction of a configuration of tile modules in a single subarray in accordance with an embodiment of the invention.

FIG. 5 is a graphical depiction of the aperture of FIG. 4A showing the location of another subarray.

FIG. 6 is a graphical depiction of the aperture of FIG. 4A showing the location of yet another subarray.

FIG. 7 illustrates the overlapped arrangement of subarray manifolds in one dimension associated with a tile module.

FIG. 8 is a graphical representation of the values of coefficients used to weight RF signals from twelve array elements in a row or column of a subarray according to one embodiment of the invention.

FIG. 9 graphically depicts the far field pattern of a phased array system having the aperture depicted in FIGS. 4A, 5 and 6.

FIG. 10 is a block diagram depicting an embodiment of a tile module having a 4×4 arrangement of array elements in accordance with the invention.

FIG. 11 illustrates a bottom view of an embodiment of a tile module in accordance with the invention.

FIG. 12 illustrates a top view of the tile module of FIG. 11.

FIG. 13 is an exploded view of the tile module of FIG. 11.

### DETAILED DESCRIPTION

In brief overview, the present invention relates to a tile module for a phased array system such as a phased array radar system or a phased array communications system. The tile module includes array elements configured in a two-dimensional array which is part of a larger subarray in the phased array system. A control module communicates with each array element to control a phase shift and an attenuation. A two-dimensional overlapped subarray manifold provides a weighted combination of RF signals received by the array elements of the tile module and array elements of other tile modules disposed in the same subarray of the phased array system. Advantageously, tile modules can be fabricated in large quantities, can be tested and calibrated independently, and can easily be installed or replaced in the phased array system.

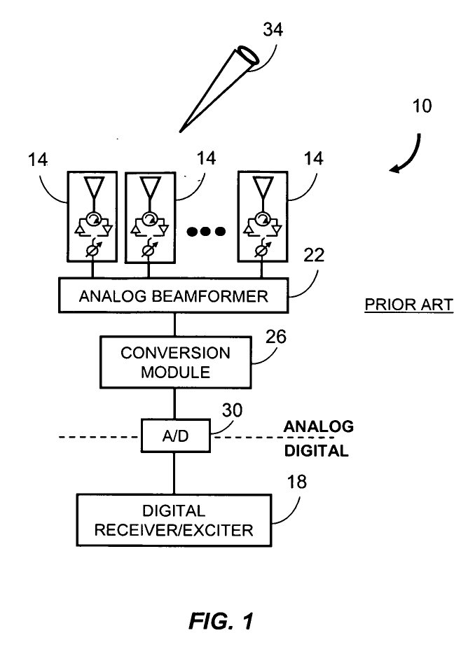

FIG. 1 illustrates a conventional active array system 10 having array elements 14 configured in a two-dimensional array. As used herein, the term array element 14 generally means an antenna element for generating or receiving an RF signal such as an RF radar signal or an RF communication signal, at least one phase shifter, and at least one amplifier. For clarity, only three array elements 14 in a single dimension are depicted. A central receiver/exciter 18 communicates with the array elements 14 through an analog beamforming network 22. The system 10 also includes a conversion module 26 to upconvert the exciter signal to the phased array RF frequency band and to downconvert RF signals from the beamforming network 22. An analog to digital converter (ADC) 30 interfaces the analog portion of the system with the digital receiver/exciter 18.

The active array system 10 operates with a single agile beam 34 for transmit and receive functions. Consequently, a single system 10 generally cannot be tasked for missions requiring multiple beams.

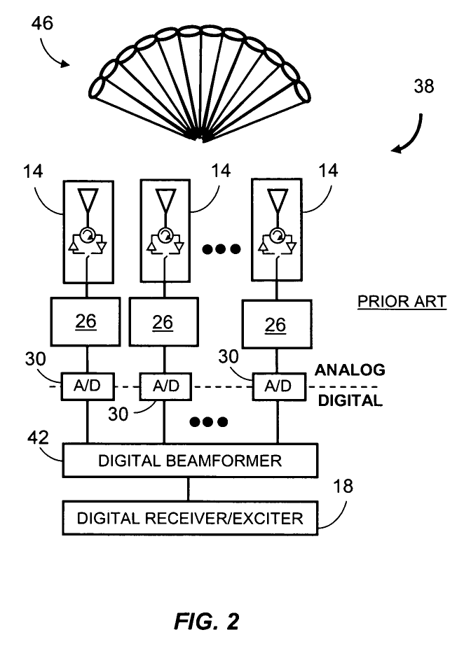

FIG. 2 illustrates an active array system 38 having a digital channel for each array element 14. A digital beamforming network 42 enables simultaneous beams 46 to be generated over the full operational space of the system 38 and fully adaptive control is possible. The fully-digital system 38 requires significant digital processing capability, increased power and thermal control. The receivers, including the conversion modules 26 and the ADCs 30, require substantial volume in addition to the volume occupied by the array elements 14. Consequently, the system 38 is generally not practical for applications where space is limited such as airborne and spaceborne surveillance platforms. Moreover, component costs may make the system 38 prohibitive, especially for applications where a significant number of systems 38 are contemplated.

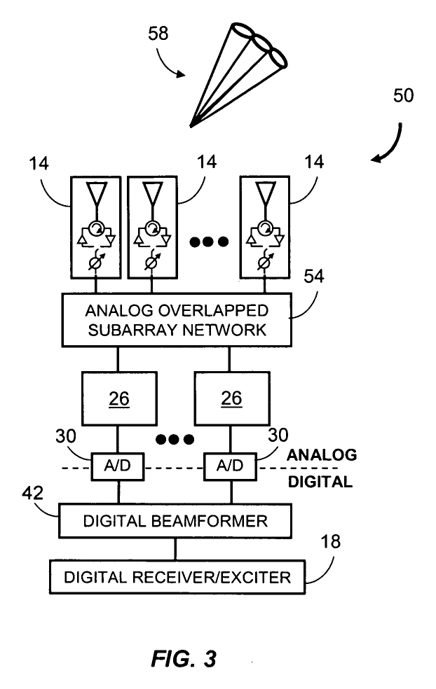

FIG. 3 illustrates an active array system 50 employing an analog overlapped subarray network 54. The number of digital channels is substantially less than the number of array elements 14 in the system 50. For example, the number of digital channels can be 5% to 10% of the number of array elements 14. Although the number of simultaneous beams 58 that can be formed by the system 50 are fewer when compared to the fully-digital system 38 of FIG. 2, the number of beams 58 can be sufficient for a wide variety of applications.

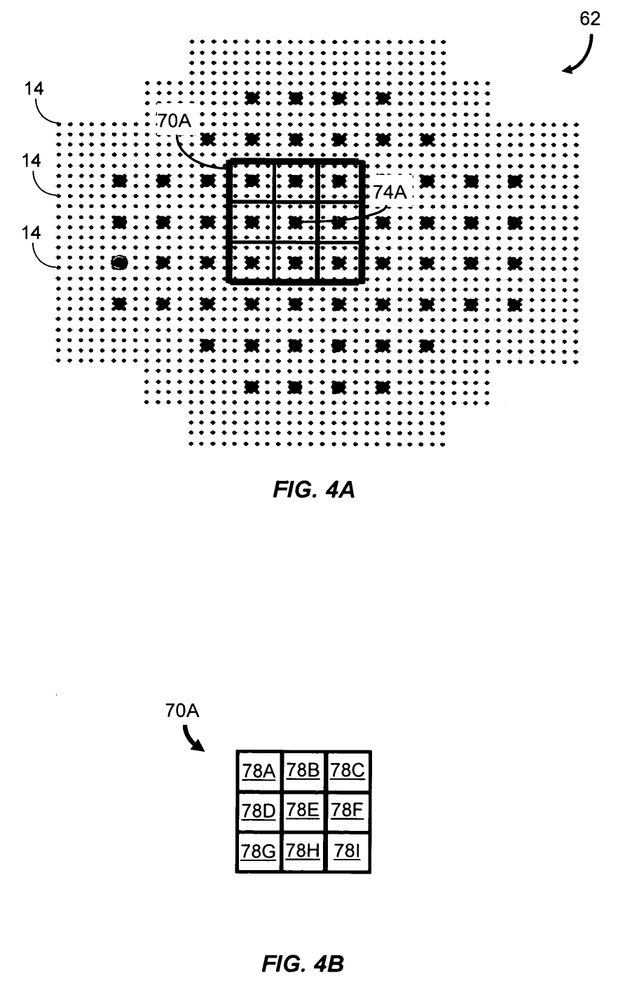

FIG. 4A graphically depicts an aperture 62 of an example of the active array system 50 shown in FIG. 3 in accordance with the invention. Each dot represents an array element 14. The array elements 14 are configured in a grid pattern having rows and columns. The aperture 62 includes a plurality of subarrays 70 arranged in an overlapped configuration. A single subarray 70A is depicted by the bolded square. Each subarray 70 includes a 12 by 12 group of array elements 14 and is referenced to a phase center (e.g., phase center 74A) defined at its geometrical center. The array elements 14 and analog overlapped subarray network 54 (see FIG. 3) for a single subarray 70 are provided by nine tile modules 78A to 78I (generally 78) arranged in a 3×3 configuration as shown in FIG. 4B. In other embodiments, the number of array elements 14 per tile module can vary and the number of tile modules per subarray can vary.

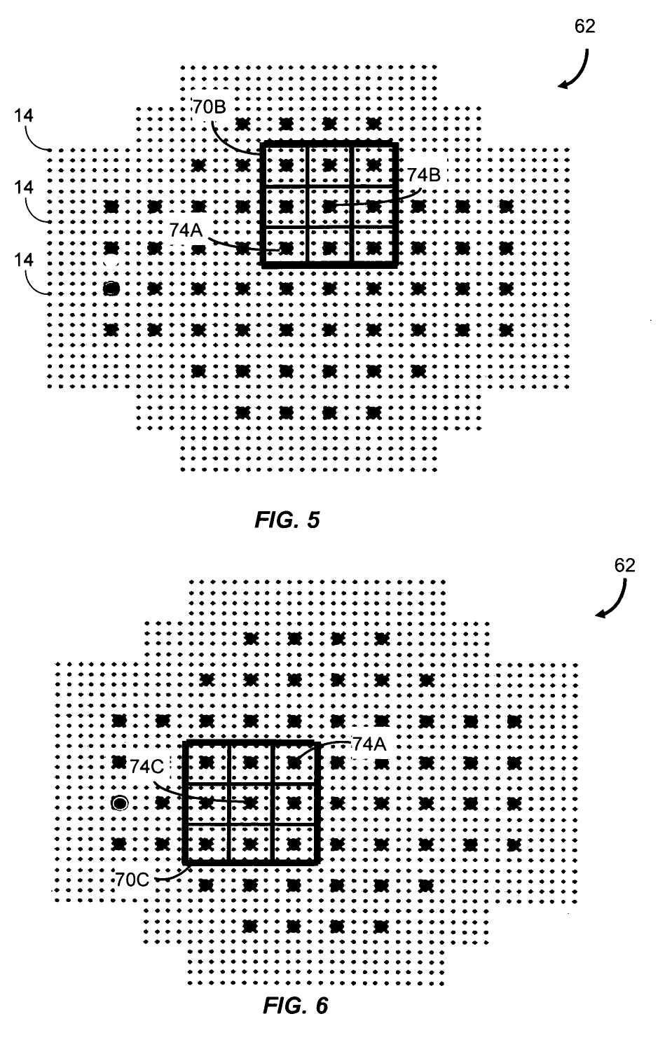

The tile modules 78 are structurally identical to each other and each includes a portion of the analog overlapped subarray network 54 for each of nine subarrays 70 in which it is a member. For example, the tile module 78E at the center of the subarray 70A shown in FIG. 4A is in the lower left position of the subarray 70B shown in FIG. 5 and is in the upper right position of the subarray 70C shown in FIG. 6. Except for tile modules 78 disposed about the periphery of the aperture 62, each tile module 78 is electrically coupled to the two adjacent tile modules in the same row of the aperture 62 and the two adjacent tile modules in the same column of the aperture 62. For example, the center tile module 78E in FIG. 4B is electrically coupled to tile modules 78B, 78D, 78F and 78H.

The tile module 78 at the center of a subarray 70, i.e., the tile module 78 centered about the phase center 74 of the subarray 70, provides an RF signal which is a weighted analog combination of the RF signals received by the array elements 14 in the subarray 70 as described in more detail below. Each tile module 78 includes a two-dimensional network module which receives RF signals from the array elements 14 in a subarray 70. A two-dimensional subarray manifold associated with the subarray 70 includes analog circuitry distributed in a center tile module and eight surrounding (i.e., adjacent) tile modules. The analog circuitry combines predefined “weights” of the RF signals from the array elements 14 as a single output signal.

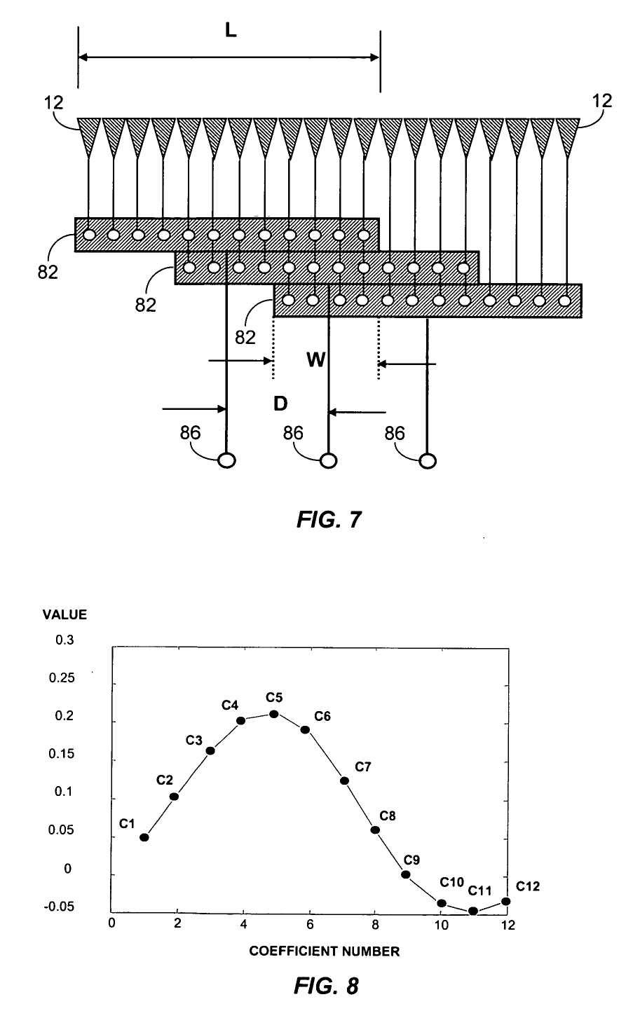

FIG. 7 functionally illustrates the overlapped arrangement of the subarray manifolds 82 associated with a single tile module 78 of width W. For clarity, the illustration is limited to the three subarray manifolds 82 in a single subarray along one dimension. Each subarray manifold 82 has a subarray width L and is “separated” from the next subarray manifold 82 by a subarray spacing D. Each subarray manifold 82 receives RF signals from a set of 12 array elements 14. For the array elements 14 in each row (or column) of the subarray, the subarray manifold 82 provides at an output terminal 86 a weighted combination of the twelve RF signals from the array elements 14 according to a set of predetermined coefficients.

Although not shown, the weighting and combining process is implemented in two dimensions. More specifically, the twelve weighted combinations that are generated for the first dimension are weighted according to another set of predetermined coefficients and combined to generate the subarray output signal. Generally, the predetermined coefficients are the same for both dimensions.

FIG. 8 graphically illustrates an example of the coefficients C1 to C12 used to weight the RF signals from the twelve array elements in a row or column of a subarray according to one embodiment of the invention. Coefficient C5 has the maximum value and is applied to the RF signal from the fifth array element along the row. Coefficients C10, C11 and C12 have negative values thus their RF signals are phase shifted by 180° relative to the nine other weighted RF signals. In one embodiment, the same coefficients are used to weight, along the orthogonal dimension, the twelve weighted combinations generated for the first dimension.

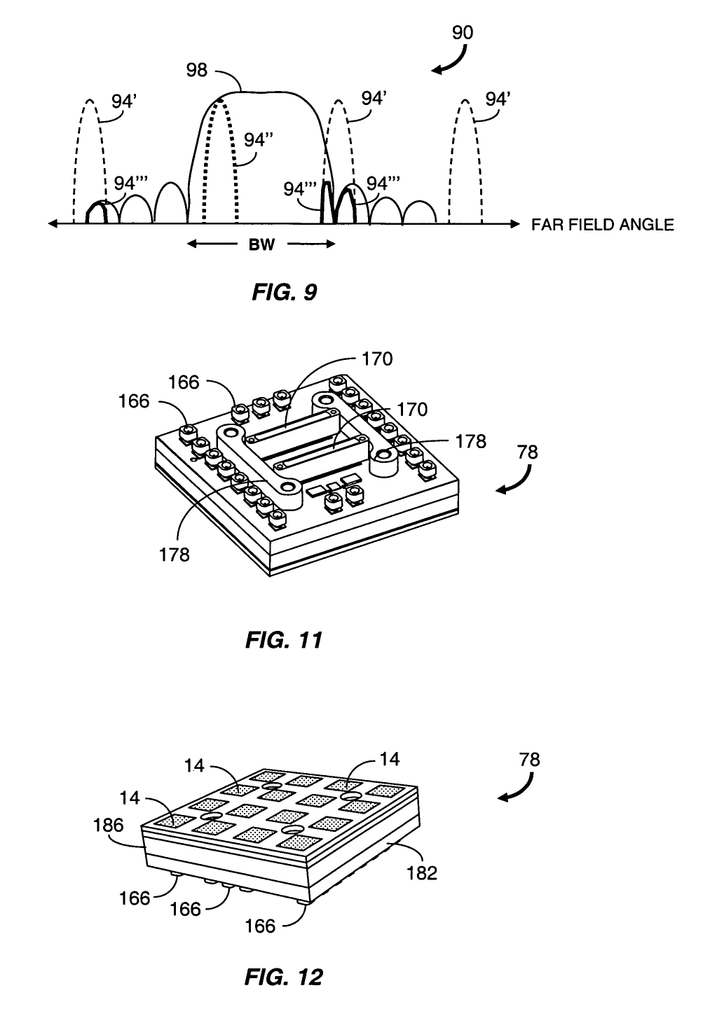

FIG. 9 graphically depicts the far field pattern 90 of the phased array system for the aperture 62 depicted in FIGS. 4A, 5 and 6. Referring to FIG. 7 and FIG. 9, the subarray spacing D is inversely proportional to the spacing of grating lobes (indicated by dashed lines 94′ and 94″) in the far field; however, due to the weighting of RF contributions in each subarray, grating lobes 94′ are suppressed according to an overlapped subarray pattern 98 while one grating lobe 94″ is substantially unaffected. The resulting suppressed grating lobes are indicated by the bold solid lines 94′″. The beamwidth BW of the overlapped subarray pattern 98 is inversely proportional to the subarray width L.

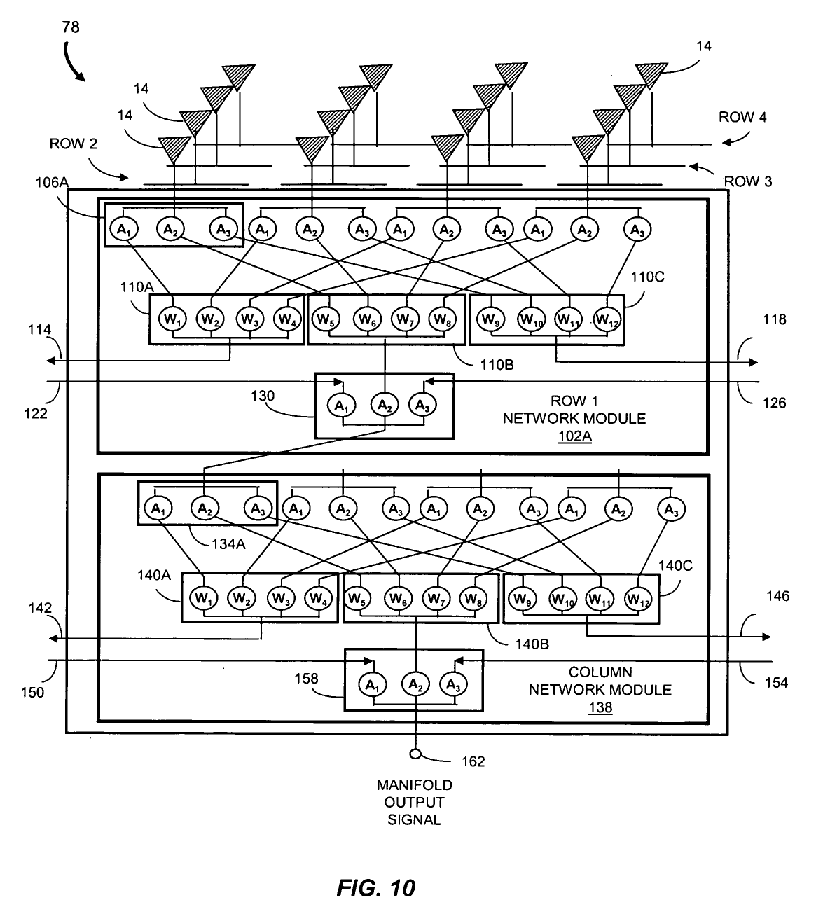

Referring to FIG. 10, an embodiment of a tile module 78 constructed in accordance with the principles of the invention includes a 4×4 arrangement of array elements 14. For each tile module 78 there are four row network modules 102A to 102D (generally 102); however, only the row 1 network module 102A corresponding to the bottom row of array elements 14 is shown for clarity. Each of the four array elements 14 associated with the row network module 102 is coupled to a respective 1:3 divider 106 (only one divider 106A is identified). Each divider 106 provides three output RF signals weighted according to one of three predetermined coefficients A1, A2 and A3. The three output RF signals from each of the four dividers 106 are provided to a respective one of three 4:1 combiners 110A to 110C (generally 110). Each combiner 110 weights its four received RF signals according to one of four predetermined coefficients W1, W2, W3 and W4.

The weighted combination of RF signals from the first combiner 110A is provided through path 114 to a respective row network module of one of two neighboring tile modules (not shown) in the same subarray that correspond to the same rows of the aperture. Similarly, the weighted combination of RF signals from the third combiner 110C is provided through path 118 to a respective row network module in the other neighboring tile module in the same rows of the aperture. Each of the two neighboring tile modules provides a weighted combination of RF signals from its respective row network module through path 122 or 126. A 3:1 combiner 130 generates a row weighted output signal by combining the weighted combinations received from respective row network modules of the two neighboring tiles with the weighted combination received from combiner 110B.

The effective weighting for each RF signal path from an array element 14 through the 1:3 combiner 130 is determined by the product of the predetermined coefficients of the 1:3 divider 106, 4:1 combiner 110 and 3:1 combiner 130 in the path. For example, the coefficient C6 is determined by the product of coefficients A2, W6 and A2. To achieve a weighting that result in a 180° phase shift, preferably each of two of the predetermined coefficients for an RF path introduces a 90° phase shift as it is generally more difficult to achieve a weighting of 180° with a single divider 106 or combiner 110, 130 over the full bandwidth.

The row weighted output signal is provided to one of four 1:3 dividers 134 (only one divider 134A is identified) in a column network module 138. Each of the three other 1:3 dividers 134 receives a weighted combination from a respective one of the other row network modules 102B, 102C and 102D in the tile module 78. The divided RF signals are weighted according to one of three predetermined coefficients A1, A2 and A3 and distributed to three 4:1 combiners 140A to 140C (generally 140) in a manner similar to that described for the row 1 network module 102A. Each of the two neighboring tile modules in the same subarray that are aligned in the same columns of the aperture receives a weighted combination of RF signals from the respective one of the first and third combiners 140A and 140C through path 142 or 146, respectively. Each of the two neighboring tile modules provides a weighted combination of RF signals from their column network modules through path 150 or 154. A 1:3 combiner 158 generates a manifold output signal at terminal 162 by combining the weighted combinations received from the two neighboring tiles with the weighted combination from combiner 140B.

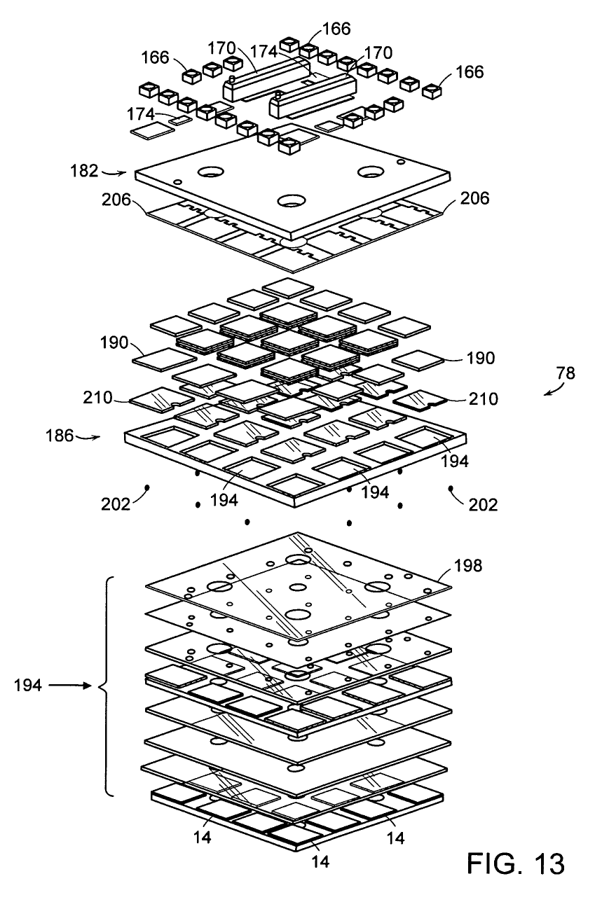

FIGS. 11 and 12 show a bottom and a top view, respectively, of an embodiment of a tile module 78 constructed in accordance with principles of the invention. Advantageously, every tile module 78 used in the phased array system is structurally identical thus fabrication of the tile modules 78 and assembly and maintenance of the phased array system are simplified. Conveniently, if one or more array elements 14 on a tile module 78 fail, the tile module 78 can easily be replaced. Moreover, tile modules 78 can be tested and calibrated independent of the phased array system.

Each tile module 78 includes all of the required overlapped subarray components. Consequently, the backplane is simplified to a set of passive electrical interconnects. The RF signals, digital control signals, and DC voltage are supplied to or from the tile module 78 via push-on electrical connectors 166 and 170. Heat generated in the tile module 78 is extracted through a set of thermal vias 178 which also serve as accurate mounting posts.

Although the illustrated tile module 78 includes a 4×4 arrangement of 16 array elements 14, it should be recognized that other numbers of array elements 14 are contemplated by the invention. Moreover, although the subarrays disclosed above are defined by a 3×3 configuration of tile modules 78, it should be recognized that a subarray can include other numbers and configurations of tile modules with the appropriate analog circuit modification to the row network modules and column network modules.

In the illustrated embodiment, the 16 array elements 14 of the tile module 78 are arranged in a 4×4 configuration along one surface. The tile module 78 also includes a two-dimensional network layer 182, an RF multi-chip module (MCM) housing 186 having 16 RF MCMs 190, RF electrical connectors 166 and DC electrical connectors 170. The two-dimensional network layer 182 includes a multi-layer dielectric board. The multi-layer board includes in-layer and between layer RF signal paths to enable combining and splitting of RF signals and to receive and distribute RF signals from other tile modules in the same subarray. The multi-layer board is also used for DC digital signal distribution for phase shifting and attenuation control and includes a power distribution network for RF MCMs 190. The RF MCM housing 186 has 16 cavities fabricated in a layer of Silicon-Aluminum (Si—Al) alloy. The alloy enables efficient heat transfer from the RF MCMs 190 and limits thermal stresses in the tile module 78. More specifically, the alloy is selected for its coefficient of thermal expansion (CTE), high thermal conductivity, low density, low resistivity, ease of fabrication and plateablity with high specific stiffness. Other alloys, composites, and metals with similar material properties can be used.

In some embodiments, the tile module 78 includes array elements 14 having two or more phase shifters to enable operation with two or more beam clusters. Each phase shifter controls the phase for a particular operating frequency band. In one example, an array element 14 has one phase shifter for a first operating frequency band (e.g., 8.5 GHz to 9.0 GHz) and a second phase shifter for a second operating frequency band (e.g., 9.5 GHz to 10.5 GHz). An RF signal resulting from a combination of the RF signals in each operating frequency band is provided by each array element 14 and processed (i.e., weighted and combined) by the subarray manifolds defined in the network layer 182. In contrast to the active array system 50 of FIG. 3, the manifold output signals are downconverted by dual band conversion modules and the RF signal for each operating frequency band is digitized by a separate ADC.

FIG. 13 is an exploded view of the tile module 78 of FIG. 11 showing how the tile module 78 is constructed. The tile module 78 includes stacked patched antenna array radiated elements 14 and layers 194 manufactured from low dielectric constant and low loss printed circuit board and foam clad materials. The layers 194 are bonded to the RF MCM housing 186 using a pressure sensitive adhesive layer 198. An array of single RF pogo pins 202 are used to bring the RF signals to an array of RF MCMs 190 through the RF MCM housing 186 contacting the backside of the RF MCMs 190. The RF MCMs 190 are bonded in an array of cavities 194 in the RF MCM housing 186 using a silver loaded perform epoxy 210. The RF MCM housing 186 is the main RF reference ground plane for the array radiated element assembly 194 and the array of RF MCMs 190. The RF ground of the RF MCM housing 186 is electrically coupled via a gold elastomer 206 with the two dimensional network layer 182, and then coupled off-tile to the backplane through the RF and digital connectors 166 and 170.

The RF MCM housing 186 is attached to the network layer 182 using a compression interface comprising a gold elastomer 206 material and the standoffs for the thermal vias 178. The standoffs are secured to the RF MCM housing 186 by screws. The gold elastomer 206 couples the RF ground between the RF MCM housing 186 and RF MCMs 190 to the network layer 182 and provides the RF ground through the RF and digital connectors 166 and 170 to the active array system.

The illustrated embodiment of the tile module 78 is described in reference to manufacture from specific materials and components. It should be realized that there are a variety of other materials having satisfactory electrical and mechanical properties that can be utilized for manufacturing the tile module 78.

Although the embodiments described above relate primarily to a receive-only phased array system, the invention contemplates the extension of this architecture to transmit functionality and a combination of transmit and receive functionality. In one approach, the overlapped subarray manifold is used for both transmit and receive signal distribution between the array elements and the subarray input/output ports. In another approach, a separate manifold is employed to distribute the transmit signals to the array elements. The former approach has the advantage of using a single overlapped subarray manifold for both transmit and receive functions; however, transmit amplifiers at each array element are required to operate in a linear mode because the overlapped subarray manifold generates a small but significant non-uniform amplitude distribution across the array. In the latter approach, the transmit signals are uniformly distributed across the array, and the transmit amplifiers can thus operate in a highly efficient saturation mode.

While the invention has been shown and described with reference to specific embodiments, it should be understood by those skilled in the art that various changes in form and detail may be made therein without departing from the spirit and scope of the invention.

What is claimed is:

1. A tile module for a phased array system comprising:
a plurality of array elements configured as a two dimensional array, each array element adapted for receiving an RF signal;
a plurality of controller modules each in communication with a respective one of the array elements and each providing a phase shift and an attenuation; and
a two-dimensional network module comprising a portion of an overlapped subarray manifold, the two-dimensional network module being in communication with the array elements and providing a weighted combination of received RF signals from the array elements of the tile module and array elements in other tile modules disposed in a same subarray of the phased array system.

2. The tile module of claim I wherein the plurality of array elements, the plurality of controller modules and the two-dimensional network module are disposed in parallel layers.

3. The tile module of claim 1 wherein the two-dimensional network module has a plurality of output terminals each adapted to electrically couple to a two-dimensional network module in adjacent tile module in the phased array system and to provide a weighted combination of a subset of the received RF signals from the array elements of the tile module.

4. The tile module of claim 1 wherein the two-dimensional network module has a plurality of input terminals each adapted to electrically couple to an adjacent tile module in the phased array system and to receive a weighted combination of a subset of the received RF signals from at least one adjacent tile module.

5. A tile module for a phased array system comprising:
a plurality of array elements configured as a two-dimensional array, each array element adapted for receiving an RF signal;
a plurality of controller modules each in communication with a respective one of the array elements and each providing a phase shift and an attenuation;
a plurality of one-dimensional network modules each in communication with a respective subset of the array elements, each one-dimensional network module generating a first weighted combination of the RF signals received by the respective subset of the array elements; and
an orthogonal one-dimensional network module in communication with the one-dimensional network modules to receive the first weighted combinations of the RF signals and to generate an orthogonal weighted combination in response thereto.

6. The tile module of claim 5 further comprising a plurality of terminals adapted to electrically couple to at least one other tile module in a same subarray to receive weighted combinations of RF signals generated by one-dimensional network modules in the at least one other tile module.

7. The tile module of claim 5 further comprising a plurality of terminals adapted to electrically couple to at least one other tile module in a same subarray to provide the first weighted combinations of the RF signals generated by the one-dimensional network modules.

8. The tile module of claim 6 wherein each one-dimensional network module generates three first weighted combinations of the RF signals and wherein two of the three first weighted combinations are provided by the terminals to two other tile modules in the same subarray.

9. The tile module of claim 5 wherein the orthogonal one-dimensional network module generates a plurality of orthogonal dimension weighted combinations and further comprising a plurality of terminals each adapted to electrically couple to another tile module in a same subarray to provide one of the orthogonal dimension weighted combinations.

10. The tile module of claim 5 wherein the one-dimensional network modules and the orthogonal one dimensional network module are disposed in a multi-layer dielectric board.

11. The tile module of claim 5 wherein the controller modules are provided in an RF multi-chip module disposed parallel to the plurality of array elements.

12. The tile module of claim 5 further comprising a digital connector in communication with the controller modules to receive command signals to control the phase shift and the attenuation for the array elements.

13. The tile module of claim 5 wherein each array element is adapted for receiving a plurality of RF signals each in a separate frequency band.

14. The tile module of claim 5 wherein receiving an RF signal comprises receiving an RF communications signal comprising communications data from a remote communications transmitter.

15. The tile module of claim 5 wherein receiving an RF signal comprises receiving an RF radar signal scattered from a radar target.

16. A phased array system comprising a plurality of tile modules each comprising:
a plurality of array elements configured as a two-dimensional array, each array element adapted for receiving an RF signal;
a plurality of controller modules each in communication with a respective one of the array elements and each providing a phase shift and an attenuation;
a plurality of one-dimensional network modules each in communication with a one-dimensional subset of the array elements in the tile module and at least one of the other tile modules in the subarray, each one-dimensional network module generating a first weighted combination of the RF signals received by a respective one of the one-dimensional subsets of the array elements; and
an orthogonal one-dimensional network module configured to receive the first weighted combinations of the RF signals and to generate an orthogonal dimension weighted combination in response thereto.

17. A tile module for a phased array system comprising:
a plurality of array elements configured as a two dimensional array, each array element adapted for transmitting an RF signal;
a plurality of controller modules each in communication with a respective one of the array elements and each providing a phase shift and an attenuation; and
a two-dimensional network module comprising a portion of an overlapped subarray manifold, the two-dimensional network module being in communication with the array elements and providing to each array element a weighted combination of transmit RF signals applied to the tile module and other tile modules disposed in a same subarray of the phased array system.

18. The tile module of claim 17 wherein the plurality of array elements, the plurality of controller modules and the two-dimensional network module are disposed in parallel layers.

19. The tile module of claim 17 wherein the two-dimensional network module has a plurality of input terminals each adapted to electrically couple to a two-dimensional network module in adjacent tile module in the phased array system and to receive a weighted transmit RF signal therefrom.

20. The tile module of claim 17 wherein the two-dimensional network module has a plurality of output terminals each adapted to electrically couple to an adjacent tile module in the phased array system and to provide a weighted RF signal thereto.

21. A tile module for a phased array system comprising:
a plurality of array elements configured as a two-dimensional array, each array element adapted for transmitting an RF signal;
a plurality of controller modules each in communication with a respective one of the array elements and each providing a phase shift and an attenuation;
a one-dimensional network module having an input terminal to receive a transmit RF signal and generating a first plurality of weighted transmit RF signals; and
a plurality of orthogonal network modules each in communication with the one-dimensional network module and a subset of the array elements, each orthogonal network module generating a plurality of weighted combinations of weighted transmit RF signals, each of the weighted combinations being provided to a respective one of the array elements.

22. The tile module of claim 21 further comprising a plurality of terminals adapted to electrically couple to at least one other tile module in a same subarray to provide a weighted transmit RF signal generated by the one-dimensional network module to each of the other tile modules.

23. The tile module of claim 21 further comprising a plurality of terminals adapted to electrically couple to at least one other tile module in a same subarray to receive weighted transmit RF signals from one-dimensional network modules in the other tile modules.

24. The tile module of claim 22 wherein the one-dimensional network module generates three weighted transmit RF signals and wherein two of the three weighted transmit RF signals are provided by the terminals to two other tile modules in the same subarray.

25. The tile module of claim 21 wherein the orthogonal network modules each provides a plurality of weighted combinations of weighted transmit RF signals and further comprising a plurality of terminals each adapted to electrically couple to another tile module in a same subarray to provide one of the weighted combinations of weighted transmit RF signals.

26. The tile module of claim 21 wherein the one-dimensional network module and the orthogonal network modules are disposed in a multi-layer dielectric board.

27. The tile module of claim 21 wherein the controller modules are provided in an RF multi-chip module disposed parallel to the plurality of array elements.

28. The tile module of claim 21 further comprising a digital connector in communication with the controller modules to receive command signals to control the phase shift and the attenuation for the array elements.

29. The tile module of claim 21 wherein each array element is adapted for transmitting a plurality of RF signals each in a separate frequency band.

30. The tile module of claim 21 wherein transmitting an RF signal comprises transmitting an RF communications signal comprising communications data to a remote communications transmitter.

31. The tile module of claim 21 wherein transmitting an RF signal comprises transmitting an RF radar signal.

32. A phased array system comprising a plurality of tile modules each comprising:
a plurality of array elements configured as a two-dimensional array, each array element adapted for transmitting an RF signal;
a plurality of controller modules each in communication with a respective one of the array elements and each providing a phase shift and an attenuation;
a one-dimensional network module having an input terminal to receive a transmit RF signal and to generate a first plurality of weighted transmit RF signals; and
a plurality of orthogonal one-dimensional network modules configured to receive the weighted transmit RF signals and to generated weighted combinations thereof for transmission from the array elements.
